(19) United States
(12) Patent Application Publication
(10) Pub. No.: US 2011/0128451 A1
(43) Pub. Date: Jun. 2, 2011

(54) APPARATUS AND METHOD FOR CONTROLLING THE OPERATION OF AN ELECTRONIC DEVICE

(75) Inventor: Ryan Easterhaus, Westfield, IN (US)

(73) Assignee: SHENZHEN TCL NEW TECHNOLOGY LTD., Shekou, Shenzhen, Guangdong (CN)

(21) Appl. No.: 13/055,115

(22) PCT Filed: Nov. 21, 2008
(86) PCT No.: PCT/US08/84321

§ 371 Date: Jan. 20, 2011

(30) Foreign Application Priority Data
Aug. 7, 2008 (CN) 200810134963.5

(51) Int. Cl. H04N 5/44; G08B 5/22

(52) U.S. Cl. 348/734; 340/6.1; 348/E05.096

(57) ABSTRACT

There is presently provided a method and an apparatus for control of an electronic device. An exemplary method comprises sending a command signal to an electronic device from a remote control and in response receiving information relating to the command from the electronic device. The exemplary method further comprises displaying an indication on a display of the remote control where the indication corresponds to the command and is constructed based on the information received from the electronic device.

### FIELD OF THE INVENTION

The present invention relates generally to remote controls. More particularly, the present invention relates to a novel remote and electronic device system which allows a user to change settings for the electronic device without obscuring the display of the electronic device.

### BACKGROUND OF THE INVENTION

This section is intended to introduce the reader to various aspects of art which may be related to various aspects of embodiments which are described and/or claimed below. This discussion is believed to be helpful in providing the reader with background information to facilitate a better understanding of the various aspects of present embodiments. Accordingly, it should be understood that these statements are to be read in this light, and not as admissions of prior art.

Electronic media devices, such as televisions, are common communications devices used in households and institutions for many purposes, such as entertainment, business, education, and information. Existing systems typically include a remote control which allows the viewer to control the device from a distance. For example, in the case of a television, the remote control may be used to change channels, adjust volume, enable closed captioning, and manipulate viewing settings. When the user presses a button on the remote control, a corresponding user-interface display typically appears on the television screen. Specifically, for instance, when the volume is adjusted via the remote control, a volume level indicator (e.g., a bar graph and/or numerical value) may appear at the bottom of the television screen. A typical remote control may also be used to configure settings on the television. For example, when a “menu” button is pressed on the remote control, a menu display may appear on the television screen. The user may then use buttons on the remote control such as up, down, right, and left, to navigate through the menu and change settings such as an aspect ratio, contrast, and parental controls.

The need to change device settings frequently arises while the viewer is watching programming on a display of the electronic media device. For example, during a television program, a viewer may want to change a brightness setting to account for outside light affecting picture quality. In another example, a viewer may want to change an aspect ratio setting to coordinate with high definition programming during viewing of the programming. However, in order to make these changes, the viewer typically must summon a menu displayed on the television screen, which partially obscures the television programming. Accordingly, viewers are often forced to choose between missing a crucial scene in the programming or waiting to change the setting.

### BRIEF DESCRIPTION OF THE DRAWINGS

Advantages of the invention may become apparent upon reading the following detailed description and upon reference to the drawings in which:

FIG. 1 is a block diagram of an electronic system in accordance with an embodiment;

FIG. 2 is an overhead view of a remote control in accordance with an embodiment; and

FIG. 3 is a process flow diagram of a method in accordance with an embodiment.

### DETAILED DESCRIPTION OF THE PREFERRED EMBODIMENT

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

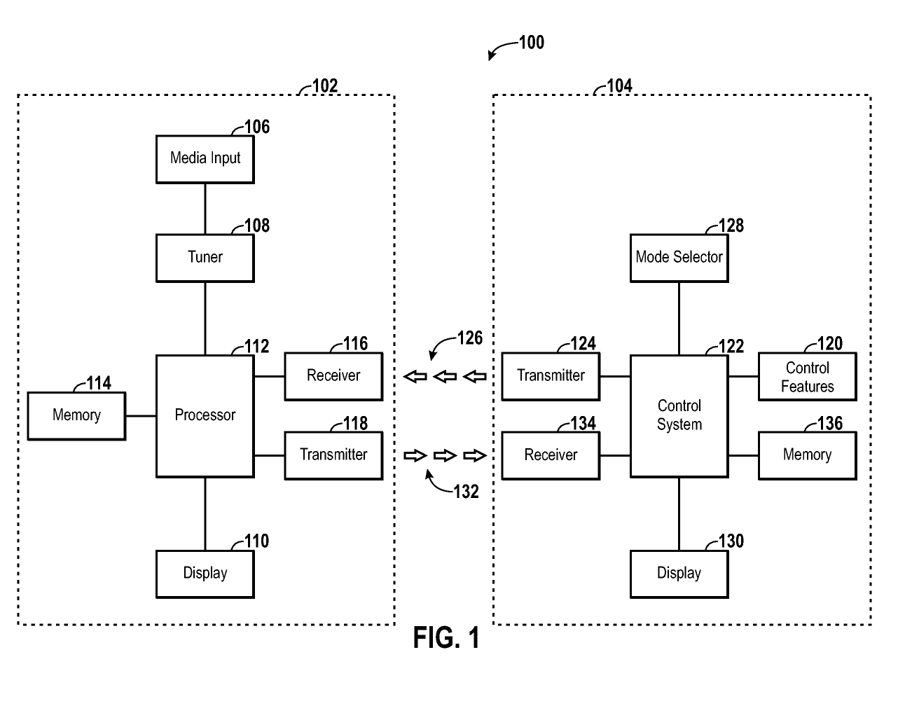

FIG. 1 is a block diagram of an electronic system in accordance with an exemplary embodiment. The electronic system, generally referred to by the reference number 100, includes an electronic device 102 and a remote control 104. The device 102 may be any electronic device capable of displaying media and controllable by the remote control 104. For example, in accordance with one embodiment, the electronic device 102 may be a television that a user can manipulate using the remote control 104. In other embodiments, the electronic device 102 may be another type of media display device, such as a computer or portable DVD player. The remote control 104 may be any type of remote control adapted to control the electronic device 102. For example, the remote control 104 may be a universal remote for controlling multiple devices or it may be a dedicated remote control used solely for controlling the electronic device 102. In the illustrated embodiment, both the electronic device 102 and the remote control 104 contain various subsystems, which are represented as functional blocks in FIG. 1. Those of ordinary skill in the art will appreciate that the various functional blocks shown in FIG. 1 may comprise hardware elements (including circuitry), software elements (including computer code stored on a tangible machine-readable medium), or a combination of both hardware and software elements.

The electronic device 102 includes a media input 106 for receiving media to display or emit via the electronic device 102. The media input 106 may be adapted to receive video and/or audio from a variety of sources. For example, the video input 106 may be an antenna or satellite dish for receiving broadcasts transmitted over the airwaves. In another embodiment, the media input 106 may be a cable input for receiving cable television channels. In yet other embodiments, the media input 106 may be a computer interface, a memory card reader, or an input for receiving information from an optical disk or the like. In some embodiments, the media input 106 may contain separate video and audio inputs for receiving video and sound, which may, or may not, correspond to each other.

A tuner 108 is configured to receive data or information from the media input 106 and/or tune a signal to provide a program for display. For example, the tuner 108 may be used to select a channel on cable television. As one skilled in the art may appreciate, certain media inputs, such as those from a DVD player or memory card, may bypass the tuner 108 because tuning is not required to isolate a video program associated with those signals.

Information received from the media input 106 may be displayed on a display 110. The display 110 may be a liquid crystal display (LCD), a light emitting diode (LED) display, a plasma display panel (PDP), a digital light projection (DLP) display, or other suitable display. The display 110 may include a lighting source (not shown) that is used to generate a visible image on the display.

A processor 112 is adapted to control operation of the device and may be adapted to execute instructions received from the media input 106 or the remote control 104. The processor 112 is configured to interact with a memory 114 that stores executable code and instructions for the processor 112. For example, the memory 114 may be adapted to hold machine-readable computer code for displaying a user interface such as a navigable menu. The memory 114 also may store menu commands in a format such as a table that correlates commands received by the processor 112 to functions executed by the electronic device 102.

In the illustrated embodiment, the electronic device 102 is configured to receive commands from the remote control 104 through a receiver 116. The receiver 116 may be any suitable receiver adapted to receive commands from the remote control 104. For example, the receiver 116 may be an infrared receiver that receives infrared signals generated by the remote control 104. In other embodiments, the communication link between the electronic device 102 and the remote control 104 may be radio frequency based employing the Bluetooth standard or another wireless communication standard. In yet other embodiments, the receiver 116 may be connected through a cable such as a Firewire connection.

In addition to the receiver 116, the electronic device 102 contains a transmitter 118 for sending signals to the remote control 104. Similar to the receiver 116, the transmitter 118 may be an infrared transmitter, radio transmitter, or combination receiver and transmitter, such as a Bluetooth transceiver. The transmitter 118 and the receiver 116 together form a two-way communication link with the remote control 104, enabling the electronic device 102 to both send signals to and receive signals from the remote control 104.

Control features 120 included within the remote control 104 may be adapted to facilitate user selection of commands for controlling the electronic device 102. The control features 120 may be manually actuatable elements such as buttons, click wheels, scroll wheels, or similar features, or any combination thereof. When a user actuates a control feature 120, a control system 122 may interpret the physical input and translate it into a command. The control system 122 may be a combination of a printed circuit board and an integrated circuit. In other embodiments, the control system 122 may include a microprocessor.

A transmitter 124 allows the remote control 104 to send signals to the electronic device 102. For example, after the control system 122 translates an input, such as physical manipulation of the control feature 120, into a command, the transmitter 124 may send this command to the electronic device 102 using a command signal 126. In addition to sending signals to the electronic device 102, the remote 104 may be enabled to receive signals from the electronic device 102. In the illustrated embodiment, a mode selector 128 is configured to allow a user to enable the remote control 104 to receive signals from the electronic device 102. The mode selector 128 may be a manually actuatable element that may also enable a display 130 or a specific function of the display 130 located on the remote control 104 when actuated. The mode selector 128 may be a button, scroll wheel, click wheel, or other manually actuatable element.

When not activated, the display 130 may be used to display status information such as the time or the date. However, upon activation, the display 130 may be used to display information from the device 102 in addition to, or instead of, status information. The mode selector 128 may operate in conjunction with the control system 122 to enable such a function of the display 130. The display 130 may be any type of display, such as a textual display, a liquid crystal display (LCD), or a light emitting diode (LED) display. In some embodiments, the display 130 may include a touch screen capable of receiving user input.

When the display 130 on the remote control 104 is active, it may be used to display a menu for navigating and communicating with the electronic device 102. For example, in an exemplary embodiment employing a television as the electronic device 102, a television menu may be displayed on the display 130 of the remote control 104. This menu which would typically be displayed on the display 110 of the television may be displayed on the display 130 of the remote control 104 instead, thus avoiding cluttering the display 110 of the television with the menu. For example, the menu may allow a user to select various settings for the television, such as brightness, contrast, aspect ratio, or parental control settings. When the display 130 on the remote control is active, the menu may be viewed on the remote control display 130 instead of the electronic device display 110, thus, enabling a user to change settings of the electronic device 102 without obstructing a portion of the device display 110. In one embodiment, the electronic device 102 detects enablement of certain features of the remote control 104 and enables or disables an on-screen menu based on such detection. For example, the electronic device 102 may be configured to only display an on-screen menu on the display 110 if the remote control 104 is not enabled to display a menu on its display 130.

The remote control 104 may receive information 132 from the electronic device 102 though a receiver 134 located on the remote control 104. The receiver 134 and the transmitter 124 form a two-way communication link with the electronic device 102, enabling the remote control 104 to both send signals to and receive signals from the electronic device 102. The information 132, such as a menu, may be displayed on the remote control display 130, or it may be used by the control system 122 to create additional information for display. For example, a memory 136 within the remote control 104 may store a table containing data corresponding to the information. In some embodiments, the memory 136 may store a graphic user interface related to the information.

The information received 132 may be in a text string format corresponding to menu parameters of the electronic device 102. In other embodiments, the information 132 may include other formats such as a graphical user interface. As noted above, the information received may be displayed in a format similar to the received information, or the information may be used to construct other formats for display. In some embodiments, the remote control 104 may be adapted to display a menu replicating the menu displayed on the electronic device 102. While the foregoing discussion refers to displaying a menu on the remote control display 130, it should be noted that the information received also may correspond to other device features such as a volume scale, channel selection, or video frame location. The remote control display 130 may be used to display information corresponding to these features as well.

As noted above, the inclusion of the receiver 134 and transmitter 124 on the remote control 104, and the inclusion of the receiver 116 and the transmitter 118 on the electronic device 102 enables two-way communication between the remote control 104 and the electronic device 102. A user is able to actuate control features 120 on the remote control 104 to send command signals 126 to the electronic device 102. The electronic device 102 receives the commands and performs corresponding functions enabled by the processor 112. The processor 112 may execute these commands by consulting tables contained within the memory 114 of the electronic device 102. The commands 126 received by the electronic device 102 also may correlate to requests for information. For example, when the mode selector 128 has been activated by a user, the command 126 sent to the electronic device 102 may include a request for menu information. Upon receiving such a command, the processor 112 may reference a table within the memory 114 that correlates the command received to information. The processor 112 may select the corresponding information and transmits it, via the transmitter 118, to the receiver 134 on the remote control 104. The receiver 134 may send this information through the control system 122 for subsequent display on display 130. In some embodiments, the control system 122 may reference a table located within the memory 136 to select additional information corresponding to the received information 132. The information may then be displayed on the display 130, allowing a user to read the information and use it to select a function on the remote control 104. The user selection may generate a new command signal that is sent to the electronic device 102, and in response to the command 126, the electronic device 102 may perform a function and may send new information 132 to the remote control 104 for display. Thus, the display 130 of the remote control 104 may change in response to user activation of features on the remote control 104. As a result, the user is able to navigate menus and functions of the electronic device 102 using a display 130 located on the remote control 104. Therefore, the navigation may occur without obstructing the device display 110.

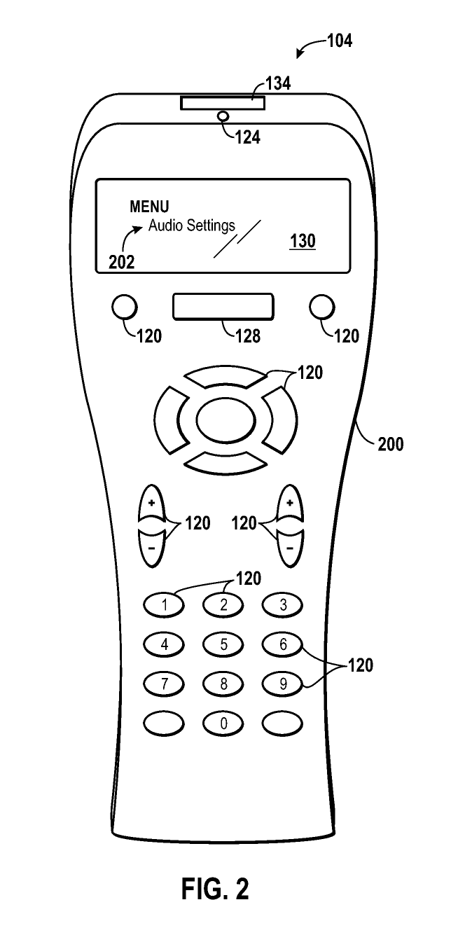

FIG. 2 is an overhead view of the remote control 104 in accordance with an exemplary embodiment. The remote control 104 includes a body 200 that encloses the remote control and protects the interior components from damage. The remote control 104 includes the transmitter 124, the receiver 134, the display 130, the mode selector 128, and the control features 120 discussed above in relation to FIG. 1. Additionally, in the illustrated embodiment, an indication 202 is shown on the display 130. The indication 202 may change in response to information 132 (FIG. 1) received from the device 102 (FIG. 1). For example, when the mode selector 128 has been selected to activate a menu or status feature of the display 130, information received from the electronic device 102 may be shown on the display 130 as an indication, such as indication 202. The indication 202 may correspond to menu parameters or features of the electronic device 102 (FIG. 1). As illustrated in FIG. 2, the indication 202 corresponds to an audio settings menu for the electronic device 102. In accordance with one embodiment, the user may actuate the control features 120 to navigate within a menu displayed on the display 130 of the remote control. For example, in one embodiment, a scroll wheel may allow the user to move up and down within the menu while a “select” button allows the user to select a menu parameter. Although FIG. 2 depicts the indication 202 as a text string, other embodiments may display other formats, including, but not limited to, a graphical user interface or a color display.

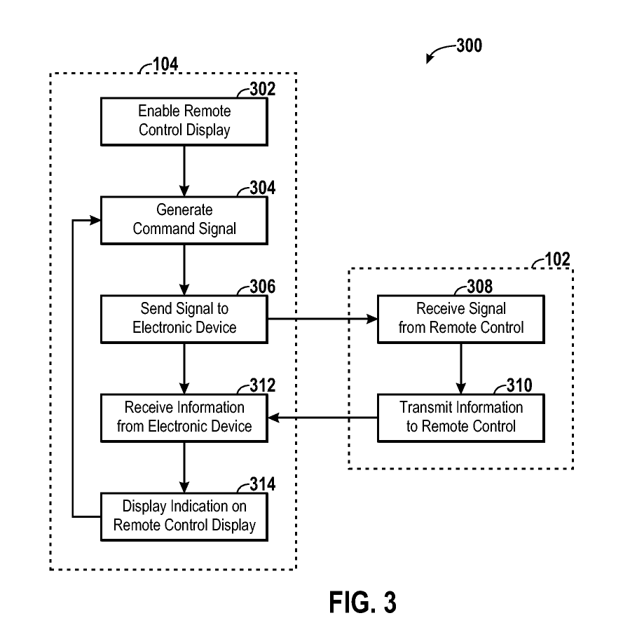

FIG. 3 is a process flow diagram of a method 300 in accordance with present embodiments. Dashed lines generally delineate the steps performed by the electronic device 102 and the steps performed by the remote control 104. In some embodiments, as would be appreciated by one of ordinary skill in the art, some steps may be modified, excluded, or additional steps may be included. The method begins with step 302, enabling the remote control display 130 or a feature of the remote control display 1340. This occurs in response to user activation of the mode selector 128 (FIG. 2). Once the display 130 is active, the remote control generates a command signal (step 304) that is sent to the electronic device via the remote control transmitter (step 306).

The electronic device 102 receives the signal from the remote control 104 (step 308) and in response generates information 132 (FIG. 1). As noted above, this information may be generated from a table that correlates command signals to information. The table may be stored within the memory 114 of the electronic device 102. The electronic device 102 then transmits the information to the remote control 104 (step 310). The remote control 104 receives the information from the electronic device 102 (step 312) and in response displays an indication on the remote control display 130 (step 314). Step 314 may include preventing display of an indication, such as a menu, on the display 110 of the electronic device 102 if the remote control display 130 is enabled. The indication 202 (FIG. 2) may be constructed directly from the information received from the electronic device 102 or the indication 202 may be constructed using the information in conjunction with data stored in the memory 136 of the remote control 104.

After the indication 202 is displayed, a user may read the information presented by the indication 25 and, in response, actuate a control feature to generate a new command signal (step 304). For example, this may include navigating a menu presented by the indication 202. This process may continue for as long as the user wishes to navigate through the menu of the electronic device 102. In some embodiments, the process may terminate when the user deselects the mode selector 128 (FIG. 2). In other embodiments, the display 130 (FIG. 2) may automatically deactivate after a period of user inactivity has occurred.

While the present embodiments may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of controlling an electronic device, the method comprising:
sending a command signal to the electronic device from a remote control;
receiving information relating to the command from the electronic device; and
displaying an indication on a display of the remote control, the indication corresponding to the command and being constructed based on the information relating to the command received from the electronic device.

2. The method of claim 1, comprising enabling the display of the remote control in response to an activation of a manually actuatable mode selector element disposed on the remote control.

3. The method of claim 1, wherein the information relating to the command is stored within a memory of the electronic device.

4. The method of claim 1, wherein the information relating to the command is stored within a memory of the remote control.

5. The method of claim 1, wherein the display of the remote control changes in response to an activation of manually actuatable buttons on the remote control.

6. The method of claim 1, wherein the electronic device comprises a television and the command signal relates to changing a menu parameter of the television, whereby the menu parameter is changed without obstructing a display of the television.

7. The method of claim 1, wherein the indication represents a menu parameter of the electronic device.

8. The method of claim 1, wherein the steps are performed in the order set forth in claim 1.

9. A remote control configured to control an electronic device, the remote control comprising:
a transmitter that is adapted to send a command signal to the electronic device;
a receiver that is adapted to receive information relating to the command from the electronic device; and
a control system that is adapted to display an indication on a display of the remote control, the indication corresponding to the command from the electronic device and being constructed based on the information relating to the command received from the electronic device.

10. The remote control of claim 9, wherein the electronic device the remote control is configured to control is a television.

11. The remote control of claim 10, wherein the command signal relates to changing a menu parameter of the television, whereby the menu parameter is changed without obstructing a device display of the television.

12. The remote control of claim 11, whereby the menu parameter is changed in response to an activation of manually actuatable buttons on the remote control, whereby the buttons are selected in response to the indication on the display of the remote control.

13. The remote control of claim 11, wherein the menu parameter comprises a contrast setting.

14. The remote control of claim 9, wherein the display of the remote control comprises a color liquid crystal display.

15. The remote control of claim 9, wherein the indication comprises a text string.

16. The remote control of claim 9, wherein the transmitter comprises a Bluetooth transceiver.

17. A method of controlling an electronic device, the method comprising:
receiving a command signal from a remote control; and
transmitting information to the remote control, the information being adapted to permit construction of an indication corresponding to the command on a display of the remote control.

18. The method of claim 17, wherein the electronic device comprises a television and the command signal relates to changing a menu parameter of the television, whereby the menu parameter is changed without obstructing a display of the television.

19. The method of claim 17, wherein the indication is constructed using values stored within a memory of the electronic device.

20. The method of claim 17, wherein the indication represents a menu parameter of the electronic device.
